(19) United States
(12) Patent Application Publication
(10) Pub. No.: US 2009/0132413 A1
(43) Pub. Date: May 21, 2009

(54) APPARATUS AND METHOD FOR SECURE CREDIT CARD PROCESSING INFRASTRUCTURE

(75) Inventor: Bo K. Engelbrecht, Stockholm (SE)

Correspondence Address: ALBIHNS STOCKHOLM AB, BOX 5581, LINNEGATAN 2, SE-114 85 STOCKHOLM; SWEDENn, STOCKHOLM, SE

(73) Assignee: RUNTIME AB, Stockholm (SE)

(21) Appl. No.: 11/719,111

(22) PCT Filed: Nov. 10, 2005
(86) PCT No.: PCT/SE2005/001695

§ 371 Date: Feb. 4, 2009

Related U.S. Application Data
(60) Provisional application No. 60/522,861, filed on Nov. 15, 2004.

(30) Foreign Application Priority Data
Nov. 15, 2004 (SE) 0402808-0

(51) Int. Cl. G06Q 20/00; G06F 1/00; G06F 3/00; G06Q 30/00

(52) U.S. Cl. 705/40

(57) ABSTRACT

The present invention relates to an apparatus and a method for secure value transactions between a customer and a merchant in a computerised environment being part of a global interconnecting network, such as the Internet. The method is adapted for utilising existing credit card processing infrastructure and includes the steps of: the customer obtaining a password, such as a PIN, from an intermediate transaction party and validating a server of the intermediate transaction party, the merchant having installed a code module function on its web-based service that generates a transaction identification number, and redirecting or presenting the customer with a link to the intermediate transaction party. The present invention is characterised by the intermediate transaction party presenting the customer with a password-protected account page to validate a purchase either by marking a correct validation or inputting the transaction identification number and amount.

### TECHNICAL FIELD OF THE INVENTION

The present invention relates to an apparatus and method for secure value transactions when purchasing products with a credit card. More in detail, the invention relates to secure value transactions between a customer and a merchant in a computerised environment in which the apparatus and method are specially adapted for utilising an existing credit card processing infrastructure.

### BACKGROUND OF THE INVENTION

During the last decade, in particular with the growth of computer applications and the increasing use of the Internet for electronic commerce, numerous approaches and technologies have been suggested for enabling secure electronic value transactions. The Internet has proved to be an efficient channel for marketing both products and services, distributing product information as well as for selecting, ordering and transferring payment for desired products and services. However, customers involved in electronic commerce have often doubted the security and integrity during electronic value transactions, irrespective of whether the transactions have been made simply via an electronic declaration of the personal credit card number or via other more complicated and allegedly secure electronic transaction methods. At present, no single electronic transaction method for electronic commerce applications has completely taken over the market as the overall dominating method, nor has any method been standardised world-wide. The reason is believed to be found, at least partly, in the user-experienced lack of absolute security and integrity of all known methods. Another reason is the complexity of suggested transaction systems and methods, which make them too expensive and often too difficult to use for an ordinary user in possession of at most average skills in computer usage.

WO 02/071176 A2 describes a financial transaction system having a set of protocols to be used within a conventional credit card processing system or environment. The described system is to be used in conjunction with a proprietary VISA 3D Secure system environment having four participating parties, i.e. merchants, issuers, card-holders and VISA itself. However, the mentioned transaction system requires the issuer to provide a central access control server for handling the issuer's part of the customer's authentication protocol.

WO 01/29637 A2 describes a system and method for conducting secure electronic transactions. A central server system is used to process and correlate proxy numbers substituting certain information that otherwise could be misused by unauthorised recipients of the information. However, a disadvantage of the system and method described is that a transaction number is to be created by the customer user interface and is subsequently to be sent to the merchant. This means that a substantial part of the administration of the transaction system is placed on the customer's own computer system, thereby leading to an additional security risk and vulnerability, which is in practice unavoidable with a system and method of the above described kind.

In addition to the above-mentioned specific disclosures of related art, also other disclosed transaction systems are afflicted with a number of shortcomings for each of the involved parties in secure value transactions. Hence, there is a need for a less complex transaction system, involving an increased level of user friendliness as well as enhanced security and built-in customer integrity.

### SUMMARY OF THE INVENTION

It is therefore an object of the invention to alleviate the previously described shortcomings of related technology. This is accomplished by an apparatus and a method for secure value transactions between a customer and a merchant in a computerised environment being part of a global interconnecting network, such as the Internet, the method being adapted for utilising existing credit card processing infrastructure and including the steps of:
the customer obtaining a password, such as a PIN, from an intermediate transaction party and validating a server of the intermediate transaction party,
the merchant having installed a code module function on its web-based service that generates a transaction identification number,
redirecting or presenting the customer with a link to the intermediate transaction party,
   characterised by
the intermediate transaction party presenting the customer with a password-protected account page to validate a purchase either by marking a correct validation or inputting the transaction identification number and amount.

One of the advantages of the invention is that the apparatus and method do not rely on any present technology, such as HTTPS (HyperText Transmission Protocol, Secure), SSL (Secure Sockets Layer—a protocol developed for transmitting private documents via the Internet) or PGP (Pretty Good Privacy—a public/private key encryption environment where a receiver is able to publish a portion of his key, which is to be used by a sender of a private message). However, use of the mentioned protocols is technically possible and will presumably even further enhance the security.

The apparatus and method according to the present invention are easy to implement, since they do not require introduction of numerous additional software packets like related technologies. Therefore, negative customer attitudes towards the invention when ordering products are avoided. Moreover, hardware required for utilising the invention is already present in existing web-based ordering and payment systems, which presence is convenient and enables the intermediate transaction party and the merchants with means to realise and quickly implement the invention.

The present invention is advantageous for all parties involved, since fraud scenarios that may occur in related technologies can be avoided to a great extent. Parties involved in the possible fraud scenarios described below are a customer, a merchant from whom the customer purchases products, and an intermediate transaction party. The intermediate transaction party may for instance be a credit card issuing company, such as previously described VISA.

In addition to the above mentioned security measures, an unreliable merchant with a card number that has previously been used at his web-site would hence fail to validate an order. Analysing TCP/IP (Transmission Control Protocol/Internet Protocol) packages to and from the merchant's server would not reveal the customer's personal password, such as PIN (personal identification number), or personal picture.

A false intermediate transaction party would not be able to confirm the order to the merchant by returning the modified random number mRN. Collaborating parties, such as a false intermediate transaction party and merchant, i.e. falsified by using a redirected hypertext link, would not present the correct graphical identification to the customer. No other protection for merchants and customers is required than the usual internal database check, which is made by the intermediate transaction party. This check is sufficient for obtaining the security needed.

Collaborating parties, such as a false customer and a false intermediate transaction party, for example by using a deceptive hypertext link, would neither be able to correctly return the modified random number (mRN). In view of the above, the present invention effectively protects the customer integrity and enhances the security of electronic value transactions, since all parties involved in transactions are prevented from tampering with the electronic transaction infrastructure and from various acts of deception.

In addition to the above-mentioned problems being solved by the present invention, another related problem to be solved is initiated by a customer using public computers for conducting an electronic business transaction. The present invention addresses the above problem in that it alleviates the vulnerability for fraud, as it does not infer any absolute requirement of instantly accepting an order and in sequence typing in a password on one single site. The customer is thus allowed to finalise the order by choosing another location or time, as long as this is done within a predetermined time-limit, the time being adjustable so as to meet specific needs of the parties involved in electronic value transactions.

### BRIEF DESCRIPTION OF THE DRAWINGS

The above and further features, advantages and benefits of the present invention will be apparent upon consideration of the following detailed description. The detailed description is to be taken in conjunction with the accompanying drawings, in which the same reference characters and figures refer to the same components or method steps throughout, and in which:

FIG. 1 depicts the apparatus and method according to the invention, where steps managed by the merchant are found on the left side of the vertical dotted line, and steps managed by the intermediate transaction party are found on the right side.

FIG. 2 outlines in a flow chart the two routes possible according to the invention to validate a transaction using graphical identification GID picture validation.

### DETAILED DESCRIPTION OF THE INVENTION

The following description is of the best mode presently contemplated for practicing the invention. The description is not to be taken in a limiting sense, but is made merely for the purpose of describing the general principles of the invention. The scope of the invention should be ascertained with reference to the issued claims.

In accordance with the present invention, a customer having stolen a credit card or credit card number would fail to validate an order because of a password protection or due to randomly placed pictures of which one single is to be correctly picked by the customer on his personal account page. In case the customer desires to change his or her personally chosen picture from one to another, a complete set of new pictures is generated. With exception for this mentioned use, the password, such as PIN, for access to the customer's personal account page at the intermediate transaction party's web page is never used during the transaction on the merchant's site. Thus, the password is neither accessible nor exposed to fraudulent use. The same applies also to the graphical identification GID sequence, which will be described below in more detail. An unreliable customer will not have the option after having validated the order to assert that the order has never taken place, nor that the amount of the order value has changed out of the customer's control. In case an incorrect product has been delivered, an optional database, arranged by either of the merchant or the intermediate transaction party, would serve as a proof of the agreement and thereby increase the reliability in the inventive system and method.

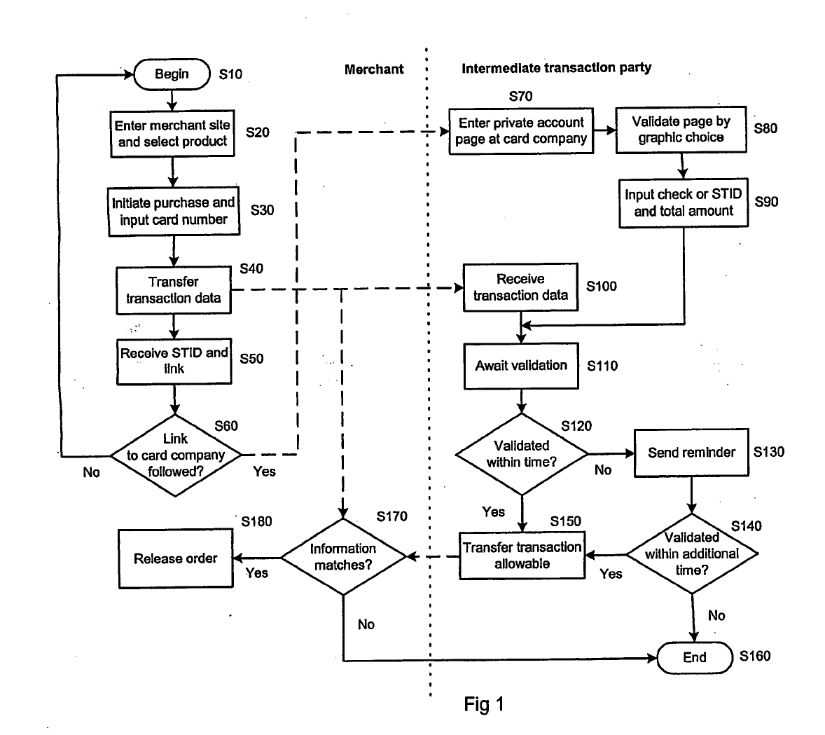

In the following, the present invention will be elucidated in more detail, with particular reference to FIG. 1, using sequential steps for clearer understanding.
1. In a first step, the customer enters a merchant's web-site and initiates an order. The order generates among other data a unique transaction identification number TID when the customer completes the order sequence (S10-S30).
2. In a second step, the merchant transfers information to the intermediate transaction party. The merchant transfers a fraction of the standard information from a credit card order and the transaction identity number TID to the intermediate transaction party. This transferred standard information could possibly also be in encrypted form using state of the art encryption technologies. This information may be transferred by earlier established systems as dial-up terminals, a proprietary network or by using the mail protocol SMTP (Simple Mail Transfer Protocol). This transaction also includes a random number for verification of the transaction validation. As was mentioned previously, the method does not require an instant confirmation of the credit card status, and thus there is no need to establish a real-time connection to the intermediate transaction party. It is to be noted that if mentioned standardised mail protocol SMTP is used, a state of the art encryption mechanism of the credit card information is preferably to be applied. In accordance with one embodiment of the present invention, public asymmetric key schemes, such as PGP, are applied (S40).
3. In a third step, the merchant directs the customer to the intermediate transaction party. The merchant presents the customer with a link from the order confirmation page to the customer's personal account page at the intermediate transaction party. It is to be noted that the presented link could point directly to the customer's personal account page by using the credit card number, a combination of information available from the credit card, or any other account number, as part of the address. This would eliminate the need to introduce cookies in the order confirmation sequence in case a direct link is presented (S60).
4. In a fourth step, the customer validates the order to the intermediate transaction party. Initially, the customer follows the link to, or is redirected to, the order confirmation on the personal account page presented by the intermediate transaction party. According to an alternative embodiment, the customer may leave the order confirmation page without following the link to the personal account page at the intermediate transaction party. This would delay the confirmation to a more convenient moment or a safer environment, for example if the customer is using a public computer with a configuration that restrains the user from deleting the content of the cache memory, or in similar ways forces the user to leave sensitive information that could be overheard or subsequently picked up. The confirmation is to be done within a time-limit set by the intermediate transaction party, merchant or customer itself. Further, this fourth step is followed by the intermediate transaction party presenting a personal and PIN code-protected page where the customer logs in to fill out a form. The page is identified by the customer as the real page transmitted from the intermediate transaction party by an earlier established graphical identification GID. When the order has reached the intermediate transaction party, the customer is presented with the merchant's company name and amount, the customer has the option to accept the order by marling a box in a form. If the order is still in transit, delayed for instance by a slow electronic mail connection or for any other technical reason, the customer is offered to accept a pending order by typing a simple transaction identification number STID and total cost without revealing information about the ordered items or who is asking for the confirmation (S70-S150).
5. In a fifth step, the intermediate transaction party confirms the order from the merchant. The intermediate transaction party confirms to the merchant, via any previously established channel, such as SMTP formatted electronic mail, that the customer has accepted the order. The information includes the simple transaction identification number STID and verifies the sender as the intermediate transaction party by including a modified random number mRN from the second step described above (S150-S180).

Alternative embodiments of the invention are that the method either could be adopted to be used with an existing credit card or introduced as a new exclusive Internet secure card that only operates on merchants' web-sites that has the system implemented. Optionally, the data sent from the merchant to the intermediate transaction party could be stored for a predetermined period of time in a database located at, or at least controlled by the intermediate transaction party and thereby serve as extra protection for all parties in the event of a dispute.

With reference to the merchant's part of the apparatus and method according to the present invention, a proprietary or non-proprietary code module function, such as for example a CGI (Common Gateway Interface, a specification for transferring information between a www-server and a CGI program, which is designed to accept and return data that conforms to the CGI specification) script, is added to the merchant's existing web-based service, in other words the web-site of the merchant. When the customer places an order, a simple transaction identification number STID is generated. The customer is then presented a link or is redirected to the intermediate transaction party's web-based service. The link is to be followed either instantly or within a predefined period of time. The intermediate transaction party server receives by any standard method, for example SMTP, the simple transaction identification number STID and credit card number from the merchant's code module function. The customer enters a password-protected page through a link at the intermediate transaction party's web server. The password can either be the PIN associated with the card, or a special PIN created for this particular purpose. A customer unique graphical identifier GID enables the customer to validate the server, even without any SSL certificate. By marking a box or typing the simple transaction identification number STID and amount, the verification of the transaction is completed and a clearance is transferred to the merchant by any standard method, for example SMTP.

With further reference to FIG. 1, additional details of the inventive method for secure value transactions are set out below. Optional steps are added to the sequential method steps according to an alternative embodiment of the present invention.
1. In a first step, the data transferred must identify the merchant to the intermediate transaction party and include data that identifies the transaction. Data includes the transaction identification number TID and the total amount to be charged to the card. None of the data transferred is of sensitive nature and could neither be misused instantly nor in future fraud activities, other than the credit card number, that could be encrypted to be less exposed. To secure the verification process, a random number RN is generated and this number is to be modified by the intermediate transaction party to be included in the reply. The modification is made in accordance with a predefined scheme. It is to be noted that an option is to transfer additional information, for example items ordered and shipping time to be verified on the customer's private page and stored in case of a later evolving dispute. As a further modification of the embodiment, it is possible to exclude the credit card number from all instances provided the customer has an account number on the intermediate transaction party web-site, i.e. the intermediate transaction party is already in possession of the number (S40-S100).
2. In a second step, the CGI script or any similar program function generates the simple transaction identification number STID and a link to the intermediate transaction party. Based on the card number, the link could possibly link directly to the customer's account on the intermediate transaction party server (S50-S60).
3. In a third step, as the customer enters the intermediate transaction party page through the link, a personal page account number or a credit card number is asked for, provided the link to the intermediate transaction party site does not include a direct link to the account. The personal account page at the intermediate transaction party site is protected by a PIN (S60).
4. In a fourth step, an account page is presented to the customer that includes a number of pictures, preferably a minimum of 15 pictures. One of the pictures, the so-called graphical identification GID picture, is in this alternative embodiment of the invention pre-installed by the customer. The position of this specific picture is dynamic and changes from one time to another, and will be random to the user. The customer has to mark the correct picture among all pictures within a predetermined time period, preferably about 2 minutes. If the customer picks the wrong picture, the activity leads to a blocking of the account. If the customer would not recognise his or her pre-installed picture, it would mean that the site is false. That would be a so-called “phishing” action, which could lead to a blocking of the account. In any case, this should make security-conscious customers to take actions and request a new PIN from the intermediate transaction party. It is to be noted that when the customer has properly both validated the picture on the account page and identified himself, an option is to securely change the identification picture freely (S80).
In accordance with one embodiment of the invention, the pictures and in particular the graphical identification GID picture, undergo image analysis in result of which the picture is adjusted. The analysis is made for instance with respect to contrast and colour depth and is made in order to avoid that the graphical identification GID picture in any way diverges from the existing reference pictures to be chosen among. Of course, also with regard to resolution and size of the GID) picture, the picture shall be brought into conformity with the existing reference pictures.
5. When having positively identified the picture and hence verified the page as belonging to the intermediate transaction party, the customer marks the box corresponding to the transaction or inputs the simple transaction identification number STID and the total amount of purchase (S90).
6. After the first time-limit has expired, an electronic mail is generated notifying the customer of the missing validation with information on which steps to take if the customer believes that a fraud attempt has been made (S120-S140).
7. Data transferred to the merchant must identify the intermediate transaction party and at least include the transaction identification number TID, the total amount of purchase and the key modified in an expected way. If incorrect or misinterpreted information is transferred, the merchant is of course able to interrupt the purchase at this stage.

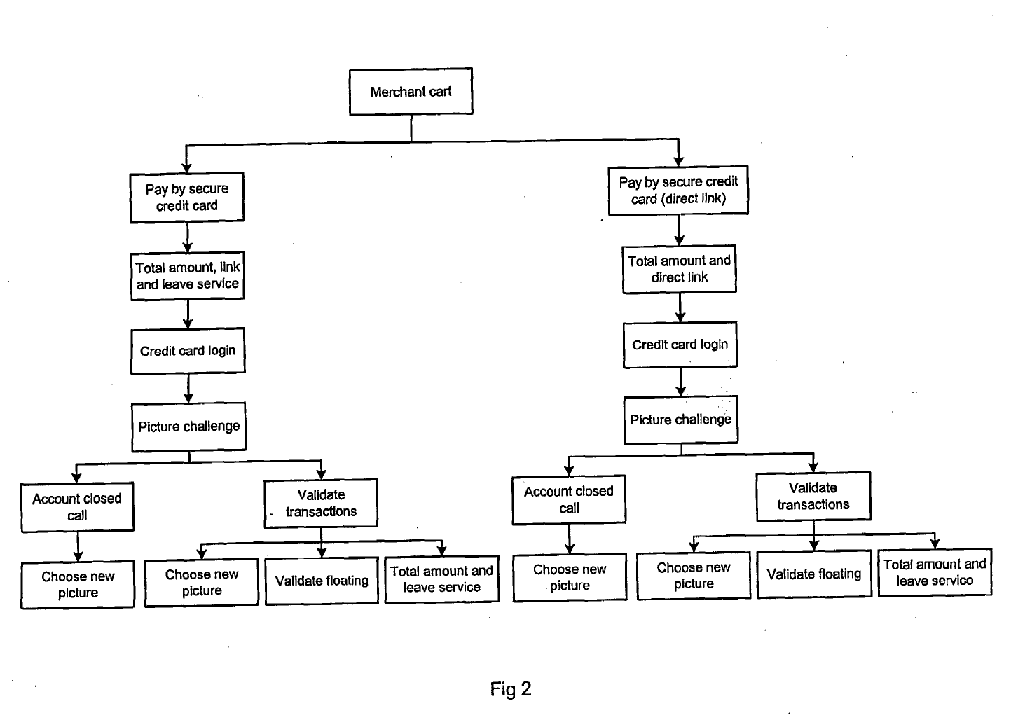

FIG. 2 outlines in a flow chart the two routes possible according to the invention in order to validate a transaction using the graphical identification GID picture validation. The figure is intended to further clarify the sequential steps according to FIG. 1, and is to be read in conjunction with the description as a whole. The left route of FIG. 2 refers to a transaction over an indirect link as described and the right route refers to payment over a direct link.

Security aspects and possible fraud scenarios of phishing will be outlined below. Possible constellations include:

### False Merchant Site:

cannot identify itself as the correct sender and thus cannot communicate with the intermediate transaction party.
False Merchant Site with a False Link Generator:
cannot present the correct graphic identification GID picture and the collected information is substantially useless. It is to be noted that this scenario demands some activities to be carried out on the customer side, as the account PIN has been exposed. If no action is taken the false merchant will be in possession of the PIN but this false merchant would most probably fail in choosing the correct picture (see S80 in FIG. 1) and therefore block the account before any purchase has been completed.

### False Intermediate Transaction Party Site:

cannot identify itself and thus cannot communicate with the merchant. Even if so, the server would return a mismatching modified random number mRN. Moreover, a correct graphic identification GID picture cannot be presented and thus, the collected information is in essence useless. It is to be noted that this scenario demands for certain actions to be taken on the customer side, as the account PIN has been exposed.
False Intermediate Transaction Party and a False Merchant Site with a Deceptive Link Generator:
cannot present a correct graphic identification GID and thus, the collected information is substantially useless. It is also to be noted that this scenario demands for certain activities to be carried out on the customer side, as the account PIN code has been exposed.
Stolen Card Numbers with at Least One Pin Include the Following Possible Constellations:

### False Customer:

cannot pick the correct graphic identification GID picture, and will therefore most likely block the account before any purchase has been completed.

### False Merchant Site and False Customer:

the merchant server cannot identify itself and thus cannot communicate with the intermediate transaction party. Moreover, the correct graphic identification GID picture is unlikely to be chosen.

### False Intermediate Transaction Party and False Customer:

cannot identify themselves and thus cannot communicate with the merchant.

### Unreliable Merchant:

cannot alter the total amount of purchase for an initiated transaction.

### Unreliable Customer:

cannot after validating an order, credibly assert that the order is incorrect or fraudulent.

Obviously and as previously mentioned briefly, wire-tapping of the customer's computer is another possible threat. There are a number of constellations of which some will be described. The first is if the keyboard use is recorded, by a so-called key logger, combined with an instant and local validation, the customer's graphic identification GID picture will still not be exposed. The second is if all information is recorded, possibly both keyboard and screen graphics by a highly advanced key and graphic logger, combined with an instant and local validation, the system may fail and make it possible to impersonate all parts of the system to the customer. The risk for these threats to occur is minimised by utilising the present invention as described.

It shall be noted that recording of in and outgoing data transfers would generate data extremely difficult to interpret even if SSL is not implemented or implemented and compromised as a result of using pictures and their random positions.

If a card number would be used in a merchant outgoing data transfer, that would be the only time for transferring information of sensitive nature. Even with all information correctly falsified in the validation, the false modified random number mRN would not be resolved when returned.

In the intermediate transaction party outgoing data transfer, no sensitive data is transferred that could be used, due to the late stage in the event sequence.

It shall be noted that the random number modifier algorithm could be revealed if it is too simple and enough of the merchant outgoing and incoming data transfer is collected.

As a general rule applicable to all of the above constellations, the communication could be protected by any standard means, such as a proprietary code algorithm identifier, leased line or similar technique in order to fulfil the highest security and protection levels against various fraud scenarios.

1. A method for secure value transactions between a customer and a merchant in a computerised environment being part of a global interconnecting network, such as the Internet, the method being adapted for utilising existing credit card processing infrastructure and including the steps of:
the customer obtaining a password, such as a PIN, from an intermediate transaction party and validating a server of the intermediate transaction party,
the merchant having installed a code module function on its web-based service that generates a transaction identification number,
redirecting or presenting the customer with a link to the intermediate transaction party,
characterised by
the intermediate transaction party presenting the customer with a password-protected account page to validate a purchase either by marking a correct validation or inputting the transaction identification number and amount.

2. A method for secure value transactions according to claim 1, comprising the steps of:
adding a code module function to the web-based service of a merchant,
the code module function generating a transaction identity as well as order details in response to the customer having placed an order,
redirecting or presenting the customer with a link to a service provided by an intermediate transaction party,
a server associated with a intermediate transaction party receiving the transaction identity and credit card information from the merchant's code module function,
the customer accessing a protected account page via the link to the service provided by the intermediate transaction party,
characterised by
validating the server access with a unique identifier for the customer, which is followed by the customer marling an existing box related to a transaction, the box verifying that the transaction is to be completed, whereby a clearance message is transferred to the merchant for allowance of the purchase.

3. The method for secure value transactions according to claim 2, characterised by
instead of marking a validation, such as marking a box, the customer manually inputting a simple transaction identity (STID) and amount relating to a transaction so as to verify that the transaction is to be completed.

4. The method for secure value transactions according to anyone of claims 1-3, characterised by
transferring or directly pointing the customer to his personal account page by using a number, such as the credit card number, as part of the address.

5. The method for secure value transactions according to anyone of claims 1-3, characterised by
the password protecting the server associated with the intermediate transaction party being the personal identification number PIN associated with the credit card.

6. The method for secure value transactions according to anyone of claims 1-3, characterised by
the password protecting the server associated with the intermediate transaction party being a specific personal identification number PIN created for this purpose.

7. The method for secure value transactions according to anyone of claims 1-3, characterised by
transferring secure information between parties involved in a transaction by electronic mail formatted according to any established protocol and technique, such as SMTP.

8. The method for secure value transactions according to anyone of claims 1-3, characterised by
if the transaction is chosen to be delayed or cannot occur in real-time, following the hypertext link to the web-based service within a pre-defined period of time, preferably so as to allow the transaction to occur at a later stage.

9. Apparatus for secure value transactions between a customer and a merchant in a computerised environment being part of a global interconnecting network, such as the Internet, the apparatus being adapted for utilising existing credit card processing infrastructure, wherein
a code module function is associated with a merchant's web-site,
the code module function is adapted to generate a transaction identity as well as order details in response to the customer having placed an order,
the customer is redirected or presented with a link to a service provided by an intermediate transaction party,
a server associated with a intermediate transaction party is provided for receiving the transaction identity and credit card information from the merchant's code module function,
access is provided the customer to a password-protected page provided by the intermediate transaction party via the link to the service,
characterised in that
a for the customer unique identifier validates the server access, in response to which the customer verifies an existing transaction or inputs a correct transaction identity and amount that verifies that the transaction is to be completed, whereby a clearance message can be transferred to the merchant for allowance of the purchase.

10. The apparatus for secure value transactions according to claim 9, characterised in that
the server of the intermediate transaction party is adapted to allow delayed confirmation of the transaction from the customer, so as to operate also without real-time connection.

11. The apparatus for secure value transactions according to claim 9, characterised in that
the link presented to the customer is a hypertext link to a web-based service provided by the intermediate transaction party.

12. The apparatus for secure value transactions according to claim 9, characterised in that
the service presented to the customer being a number of randomly placed pictures, provided by the intermediate transaction party, of which pictures the customer is to identify and choose one.

13. The apparatus for secure value transactions according to claim 9, characterised in that
the service presented to the customer being a number of randomly placed pictures, provided by the intermediate transaction party, of which one picture is to be chosen.

14. The apparatus for secure value transactions according to claim 13, characterised in that
the one picture to be chose initially having been uploaded by the customer and/or having been selected by the customer from a set of pictures presented by the intermediate transaction party.

15. The apparatus for secure value transactions according to claim 9, characterised in that
the code module function added to the merchant's web-site is any proprietary or non-proprietary code module function, such as CGI (Common Gateway Interface), Agent or code like PHP (Hypertext Preprocessor).

16. Computer program product for integral installation into existing infrastructure for secure value transactions between a customer and a merchant, the infrastructure being part of a global interconnecting network, such as the Internet, characterised in that
the computer program product being adapted to carry out the method steps of anyone of claims 1-8.
